(19) United States
(12) Patent Application Publication
(10) Pub. No.: US 2013/0166426 A1
(43) Pub. Date: Jun. 27, 2013

(54) Method to Convert Limited Liability Company (LLC) into C Corporation and Therein Subsequently Take It Public

(71) Applicant: Kevin A. Diehl, Mason City, IA (US)

(72) Inventor: Kevin A. Diehl, Mason City, IA (US)

(21) Appl. No.: 13/338,119

(22) Filed: Dec. 27, 2011

(51) Int. Cl. G06Q 40/06

(52) U.S. Cl. 705/37

(57) ABSTRACT

For the purposes of taking any LLC public, the present invention provides for the novel sequential methodology of converting an LLC into any C corporation and then taking this entity that used to be an LLC public. The present invention also provides for the utilization of any electronic means of communication to implement this conversion, such as the computer-implemented sequential methodology of contracting for and converting the LLC into the C corporation with the subsequent issuance of stock for purposes of taking it public.

### RELATED APPLICATIONS

| | | |
|---|---|---|
| 7,769,657 | August 2010 | Chacko et al. |

(The first claim for which the patent was granted involves some financial process similar to the current invention without any use of technology (without the use of any computer technology) (entirely business method patent for this claim).)

| | | |
|---|---|---|
| 7,689,496 | March 2010 | Cobrinik et al. |
| 7,376,604 | May 2008 | Butcher |

(The entire invention for which the patent was granted involves some financial process similar to the current invention without any use of technology (without the use of any computer technology) (entirely business method patent).)

| | | |
|---|---|---|
| 7,376,607 | May 2008 | Recupero |

(The entire invention for which the patent was granted involves some financial process similar to the current invention without any use of technology (without the use of any computer technology) (entirely business method patent).)

| | | |
|---|---|---|
| 7,319,984 | January 2008 | Frankel et al. |

(The entire invention for which the patent was granted involves some financial process similar to the current invention without any use of technology (without the use of any computer technology) (entirely business method patent).)

| | | |
|---|---|---|
| 7,310,616 | December 2007 | Sugahar |

(The entire invention for which the patent was granted involves some financial process similar to the current invention without any use of technology (without the use of any computer technology) (entirely business method patent).)

| | | |
|---|---|---|
| 7,222,094 | May 2007 | Ross |

(The entire invention for which the patent was granted involves some financial process similar to the current invention without any use of technology (without the use of any computer technology) (entirely business method patent).)

### FIELD

The present invention relates to the field of taking an LLC public. More specifically, the present invention describes the novel sequential methodology of taking any LLC public through the conversion into the C corporation and then the subsequent issuance of stock.

### BACKGROUND

Relatively recently, the states finished passing legislation creating the entity, the limited liability company (LLC). This new form of entity provides limited liability to owners called members to the same extent that corporations would provide to their shareowners. However, unlike for corporations then, there is no way to take LLCs public. Their members could try to sell the assets of the LLC or sell member interests to others. However, the result in no way comes close to taking the LLC public. As more and more LLCs are formed, this issue becomes more and more important to resolve. The solution is to convert the LLC into the C corporation. This unique conversion would permit the former LLC then immediately to issue stock in the public markets as the C corporation.

### SUMMARY

The present invention involves taking an LLC public through the novel sequential methodology of converting the LLC into the C corporation and then taking the entity that used to be the LLC public. The present invention also provides for the utilization of any electronic means of communication to implement this conversion, such as the computer-implemented sequential methodology of contracting for and converting the LLC into the C corporation combined with the subsequent issuance of stock for purposes of taking it public.

### DRAWINGS' DESCRIPTION

FIG. 1 shows the transfer of the LLC's assets to the C corporation and the subsequent taking public.

FIG. 2 shows the transfer of the LLC's assets to the C corporation and the subsequent taking public but with the utilization of computer processing at various parts of the methodology.

FIG. 3 shows the transfer of the LLC's assets to its members and the subsequent taking public.

FIG. 4 shows the transfer of the LLC's assets to its members and the subsequent taking public but with the utilization of computer processing at various parts of the methodology.

FIG. 5 shows the transfer of the LLC members' interests in exchange for C corporation stock and the subsequent taking public.

FIG. 6 shows the transfer of the LLC members' interests in exchange for C corporation stock and the subsequent taking public but with the utilization of computer processing at various parts of the methodology.

### DETAILED

As required, detailed embodiments of the present invention are disclosed herein. However, it is to be understood that the disclosed embodiments are merely illustrative of the invention that can be embodied in various forms. Thus, specific structural and functional details disclosed herein are not to be interpreted as limiting but merely as the basis for the claims and as the representative basis for educating those individuals skilled in the art variously to employ the present invention.

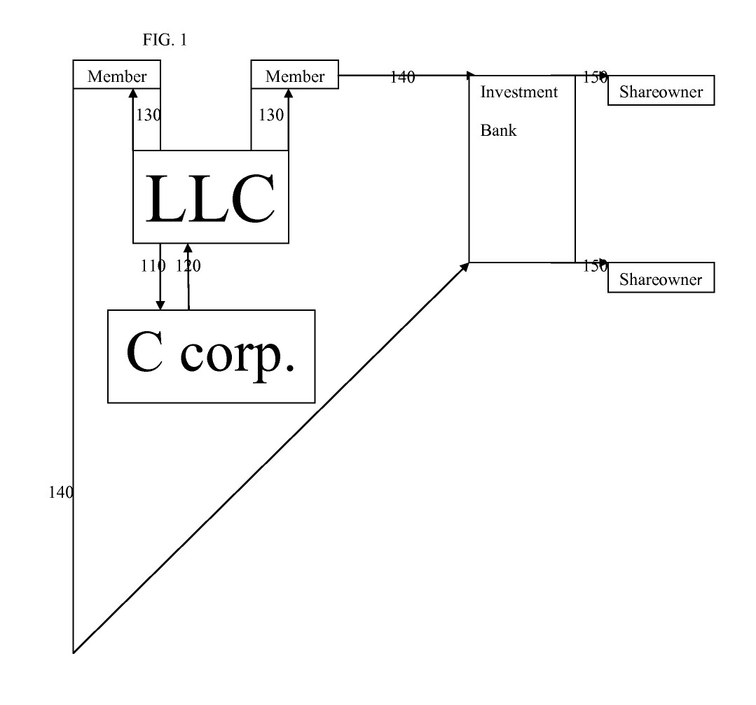

FIG. 1 shows the transfer of the LLC's assets at 110 to the C corporation in exchange for stock at 120 that the LLC then distributes to its members at 130 and 130. The former members of the LLC are now shareowners in the C corporation. The shareowners then distribute their shares to the investment bank at 140 to take the former LLC public. The investment bank buys the shares from former LLC members to take the former LLC public at 150 and 150.

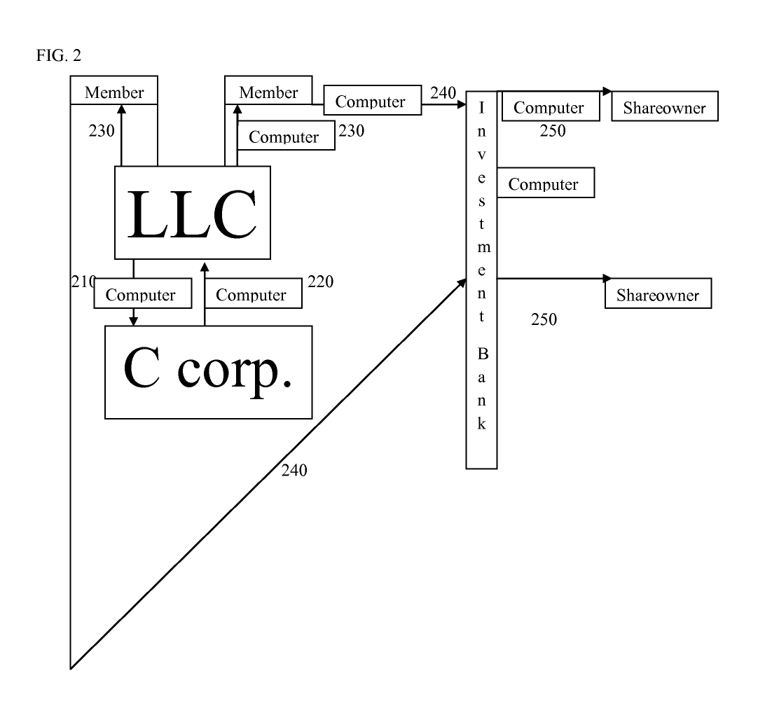

FIG. 2 shows the transfer of the LLC's assets to the C corporation at 210 in exchange for stock at 220 that the LLC then distributes to its members at 230 and 230. The computer-implemented means of the transaction are illustrated as part of or all the assets are transferred through computer processing of the change of title from the LLC to the C corporation at 210; the C corporation's transfer of shares to the LLC can occur in part or in its entirety through computer processing at 220; the transfer of shares from the LLC to the former members of the LLC can then occur partially or completely through computer processing at 230; the transfer of shares from the former members of the LLC (now shareowners in the C corporation) to the investment bank or syndicate of investment banks to take the former LLC public can then occur partially or completely through computer processing at 240; and the investment bank can utilize computer processing to gauge market pricing to buy the shares from the former LLC members and then can utilize computer processing to transfer part of or all its shares to the public at 250.

The previous illustrations are the preferred embodiments. However, in similar fashion but without requiring drawing disclosure because of the extreme similarity, the following variations are possible. As the first mutually exclusive variation alternative to the LLC distributing its assets to the C corporation in exchange for the stock of the C corporation that the LLC distributes to its members, the LLC could instead distribute its assets to the C corporation and then liquidate, permitting the C corporation to distribute its shares directly to the former LLC members. The only difference with FIG. 1 is leaving out 120 and having 130 be the transfer directly from the C corporation to the former LLC members, not to the LLC and subsequently to the former LLC members. The computer processing could be involved in similar respects to FIG. 2 but without the possibility of involvement in 220 and differently in 230 as involved with the transfer between the C corporation and the former LLC members, not the LLC and the former LLC members.

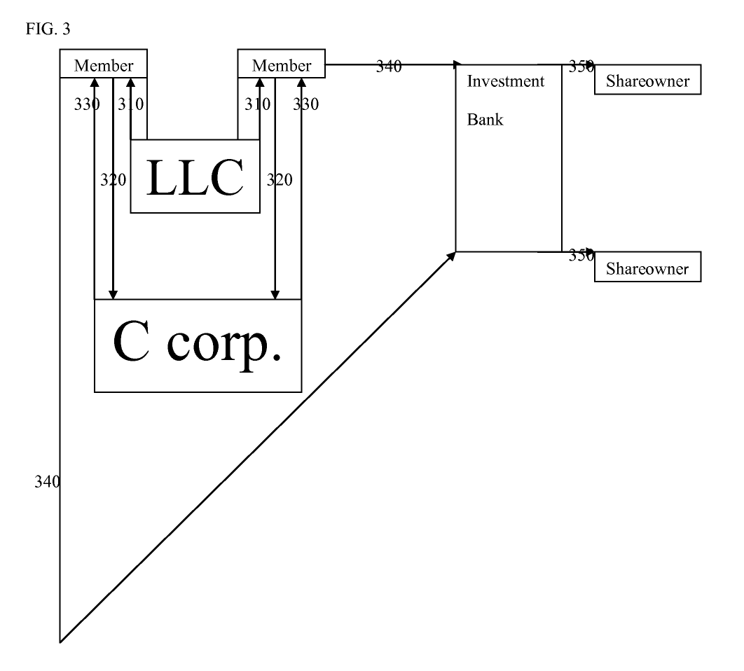

In FIG. 3 as the second mutually exclusive variation alternative to the LLC distributing its assets to the C corporation in exchange for the stock of the C corporation that the LLC distributes to its members, the LLC could liquidate and therein distribute its assets to its members at 310 and at 310 who then distribute those assets to the C corporation at 320 and at 320 in exchange for stock in the C corporation at 330 and at 330.

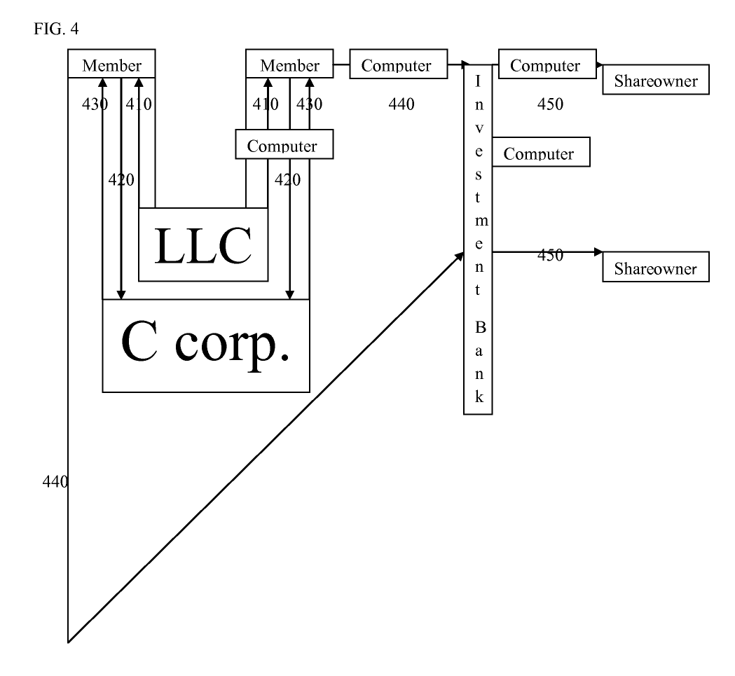

In FIG. 4 then, the computer processing could be involved with part of or all the LLC liquidation and distribution of assets to the members by transferring title at 410. It could be involved with part of or all the transfer of the assets to the C corporation at 420 in exchange for stock to those former LLC members at 430. The computer processing could then be part of or all the work that the investment bank does and part of or all the transfer of stock to the investment bank at 440. Then, it could be part of or all the investment bank's transfer of stock from the investment bank to the public at 450.

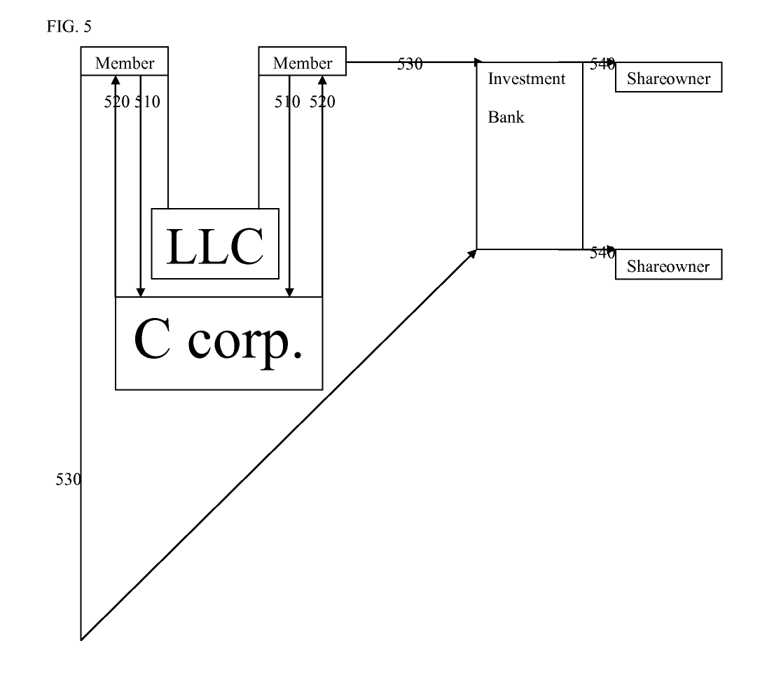

In FIG. 5, the final mutually exclusive variation alternative to the LLC distributing its assets to the C corporation in exchange for the stock of the C corporation that the LLC distributes to its members, the members of the LLC could instead distribute their member interests at 510 and at 510 to the C corporation in exchange for the shares in the C corporation at 520 and at 520.

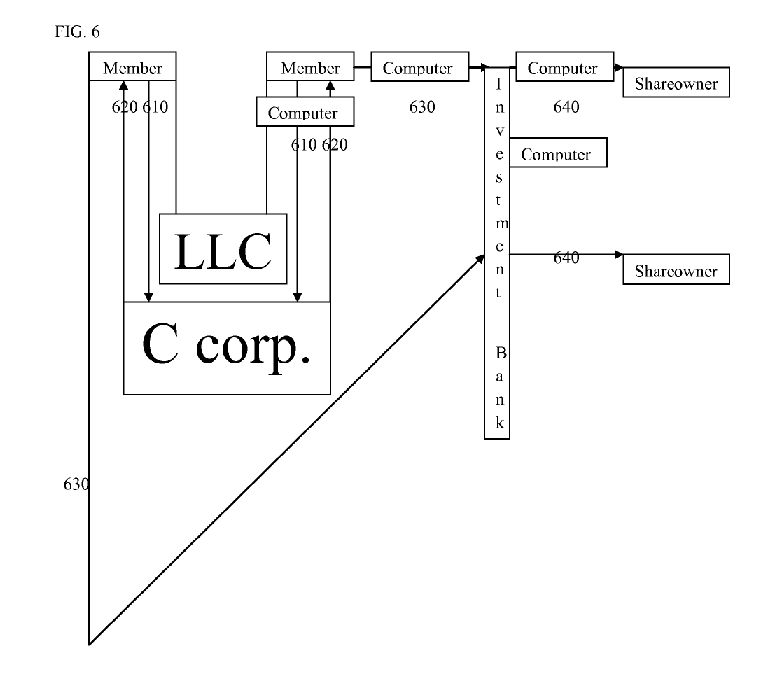

In FIG. 6 then, the computer processing could be involved as part of or all the transfer of member interests to the C Corporation at 610 and the transfer of the C corporation's shares in to the former members of the LLC at 620. The computer processing could continue with part of or all the transfer of C corporation stock from the former LLC members to the investment bank at 630. Then, the computer processing could help the investment bank with its normal activities in taking the shares public at 640.

While many embodiments of the present invention have been described, it is understood that these embodiments are illustrative only and not restrictive.

It should also be understood that many modifications could become apparent to those individuals of ordinary skill in the art. For instance, taking the LLC public can be through the utilization of what is considered to be common stock, preferred stock, bonds, convertible stock or bonds, hybrid items, derivatives, etc. with the preferred embodiment as common stock nonetheless. Also, the entire sequential method could involve more than just the investment bank but instead some syndicate of investment banks Furthermore, more than one LLC could be involved, and more than one C corporation could be involved. Also, to the extent that LLCs evolve over time, they could take on different names, such as limited liability partnerships or some name not known at this point. However, these name changes would not modify the substance of this invention and therein still be within this invention's language.

What is claimed is:

1. The method of converting an LLC into the C corporation status and therein taking it public, comprising (i) the transfer of assets from the LLC to the C corporation in exchange for stock then distributed to the former LLC's members; (ii) the transfer of assets from the LLC to the C corporation, the LLC liquidating, and the C corporation transferring the shares to the former LLC's members; (iii) the transfer of assets from the LLC to its members (the LLC therein liquidating) who then transfer the assets to the C corporation in exchange for stock; or (iv) the transfer of member interests to the C corporation in exchange for shares and, then regardless of whether (i), (ii), (iii), or (iv) is implemented, the subsequent transfer of those so received shares to an investment bank or syndicate of investment banks to take the former LLC public.

2. The method of claim 1, wherein any electronic communication is utilized to do the contracting for or actually do any part of or all the tasks.

3. The method of claim 1, wherein computer-implemented processing is utilized to do the contracting for or actually do any part of or all the tasks.

4. The method of claim 1, wherein the LLC can liquidate at any point or remain in existence as the choice of the former or current members of the LLC.

5. The method of claim 1, wherein only one member exists.

6. The method of claim 1, wherein any number of members and subsequent shareowners can exist.

7. The method of claim 1, wherein the methodological sequence can occur almost instantaneously or with long delay between the parts.

8. The method of claim 1, wherein the LLC can be foreign and the C corporation domestic, the LLC can be domestic and the C corporation foreign, the LLC and the C corporation can be foreign, or the LLC and the C corporation can be domestic.

9. The method of claim 1, wherein the “investment bank” can be the provider of Dutch auctions or any alternative means of offering the shares to the public.

10. The method of claim 1, wherein not all the members give their shares to the investment bank to be taken public.

11. The method of claim 1, wherein not all the members elect to receive stock from the C corporation but wherein some members elect to receive assets from the LLC rather than remaining through the process to receive shares in the C corporation.

12. The method of claim 1, wherein the C corporation does not take all the assets of the LLC.

13. The method of claim 1, wherein the C corporation does not issue all its stock in exchange for assets.

14. The method of claim 1, wherein more than one C corporation is involved, such as, for example and as not exclusive, the transfer of assets is made to the subsidiary of the parent C corporation who then issues its own stock in exchange for those assets or the transfer of assets is made to the parent C corporation who then makes its subsidiary distribute stock in exchange for the transfer of assets.

15. The method of claim 1, wherein more than one LLC is involved, such as the transfer of assets is made from more than one LLC in exchange for stock in the C corporation.

16. The method of claim 1, wherein the C corporation distributes common stock, preferred stock, bonds, or some combination of these items and others in exchange for the assets.

17. The method of claim 1, wherein “limited liability partnership” can be substituted for LLC because some states have an exactly same limitation of liability entity but called it limited liability partnership rather than LLC.

18. The method of claim 1, wherein any newly created limited liability entity form can be substituted for LLC.

19. The method of claim 1, wherein an intermediary is (or group of intermediaries are) utilized to permit the transactions to occur.

20. The method of claim 1, wherein an investment bank or the syndicate of investment banks provides all or part of the advice for the method of taking the LLC public.
